(19) United States
(12) Patent Application Publication
(10) Pub. No.: US 2026/0153199 A1
(43) Pub. Date: Jun. 4, 2026

(54) FUELING VEHICLE AND METHOD

(71) Applicant: Transportation IP Holdings, LLC, Norwalk, CT (US)

(72) Inventors: Christopher Joseph Homison, Wattsburg, PA (US); Gregory Wright, Longmont, CO (US)

(73) Assignee: Transportation IP Holdings, LLC, Norwalk, CT (US)

(21) Appl. No.: 18/967,554

(22) Filed: Dec. 3, 2024

(51) Int. Cl. F17C 13/08

(52) U.S. Cl. CPC F17C 13/083; F17C 2223/0161; F17C 2225/0161

(57) ABSTRACT

A system including a first interface device couplable to a first vehicle. The first interface device may include a first fuel conduit portion. Additionally, the system includes a second interface device couplable to a second vehicle. The second interface device may include a second fuel conduit portion. The first conduit portion and the second fuel conduit portion may be fluidically coupled to define a continuous fuel conduit from the first vehicle to the second vehicle. The continuous fuel conduit can be configured to elastically deform to maintain fluid communication during operation of the first vehicle and the second vehicle while transferring fuel from the first vehicle to the second vehicle.

### BACKGROUND

### Technical Field

The subject matter described herein relates a system and method for a fueling vehicle.

### Discussion of Art

In various applications, vehicles relying on gaseous fuel, such as hydrogen, often require more fuel storage space than vehicles relying on liquid fuels. Storing gaseous fuels in a liquid state at cryogenic temperatures and/or high barometric pressures may offset low volumetric density inherent in gaseous fuels. Yet even with the increased volumetric energy density of storage in a liquid state, the fuel storage system may need to be located offboard the propulsion generating vehicle and, instead, be placed in a separate vehicle in order to store comparable amounts of energy as liquid fuels.

Storage of gaseous fuels in a liquid state may require additional equipment and management strategies to condition (e.g., pressurize, vaporize, warm, etc.) the fuel for use in the propulsion-generating vehicle. However, the time required to change the state of the fuel may be longer than the time required for the multi-vehicle system to change its operating state (e.g., start up, power level change, shutdown, etc.) and, in turn, change the propulsion-generating vehicle's demand for fuel. This timing mismatch can result in lengthened startup times and failure to maintain fuel conditions within allowable limits during operation, which may lead to reduced performance, damage, and/or shutdown of the multi-vehicle system. Additionally, such timing mismatch may result in slower vehicle transient response and increased loss of fuel to venting due to overpressure.

While increasing the capacity of the fuel storage system relative to the power required by the vehicle is known to mitigate some of the issues described herein, it may aggravate others. Accordingly, it may be desirable to have a vehicle interface system and method of use thereof that differs from those that are currently available.

### SUMMARY

In one example, a system is provided. The system may include a first interface device couplable to a first vehicle. Further, the first interface device may include a first gaseous fuel conduit portion. Additionally, the system may include a second interface device couplable to a second vehicle. The second interface device may include a second gaseous fuel conduit portion. The first gaseous conduit portion and the second gaseous fuel conduit portion may be fluidically coupled to define a continuous gaseous fuel conduit from the first vehicle to the second vehicle. The continuous gaseous fuel conduit can elastically deform to maintain fluid communication during operation of the first vehicle and the second vehicle while transferring gaseous fuel from the first vehicle to the second vehicle.

In one example, a system is provided. The system may include a first interface plate couplable to a first vehicle. The first interface plate may include a moveable arm, a first connector, and a first alignment feature. Additionally, the system may include a second interface plate couplable to a second vehicle. The second interface plate may include a second connector that can matingly engage the first connector and a second alignment feature config that can receive the first alignment feature. Further, the movable arm may be actuatable to matingly engage the first connector to the second connector.

In one example, a method is provided. The method may include directing a first vehicle with a first interface and a second vehicle with a second interface device to approach each other. The method may further include determining a distance between the first interface device and the second interface device. Additionally, the method can include engaging a gas tight seal between the first interface device and the second interface device in response to the determined distance being less than a threshold distance.

### BRIEF DESCRIPTION OF THE DRAWINGS

The subject matter may be understood from reading the following description of non-limiting embodiments, with reference to the attached drawings, wherein below:

FIG. 1 illustrates a multi-vehicle system in accordance with at least one aspect of the present disclosure;

FIG. 2A illustrates two fluidically couplable interface devices in accordance with at least one aspect of the present disclosure;

FIG. 2B illustrates a front view of an interface device in accordance with at least one aspect of the present disclosure;

FIG. 2C is a section view of an interface devices at Section 2C as shown in FIG. 2A;

FIG. 3A illustrates a protective system for an interface device in accordance with at least one aspect of the present disclosure;

FIG. 3B illustrates a front view of the protective system in accordance with at least one aspect of the present disclosure;

FIG. 4 illustrates an additional protective system for an interface device in accordance with at least one aspect of the present disclosure; and

FIG. 5 illustrates a flowchart of one example of a method for interfacing two interface devices in accordance with at least one aspect of the present disclosure.

### DETAILED DESCRIPTION

Embodiments of the subject matter described herein relate to a fueling vehicle and interface system and method of use thereof. An embodiment may simplify and automate the process of coupling a gaseous fuel conduit and other desired connections between two vehicles. Such a system, as described herein, may facilitate a fluidic connection between multiple vehicles. This may be accomplished with little to no human intervention. Further, such an interface system may maintain the fluidic connection during operation of the vehicles. To do so, the interface system may include one or more features to aid, monitor or ensure the reliability of the interface and the safety of those operating and/or supporting the vehicle system.

A system is provided in one embodiment, that has a first and a second interface. The first interface device may be couplable to a first vehicle and may have a first fuel conduit portion. The second interface device may be couplable to a second vehicle and may have a second fuel conduit portion. The first fuel conduit portion and the second fuel conduit portion are fluidically coupled to define a continuous fuel conduit from the first vehicle to the second vehicle. The continuous fuel conduit can elastically deform to maintain fluid communication during operation of the first vehicle and the second vehicle while transferring fuel from the first vehicle to the second vehicle.

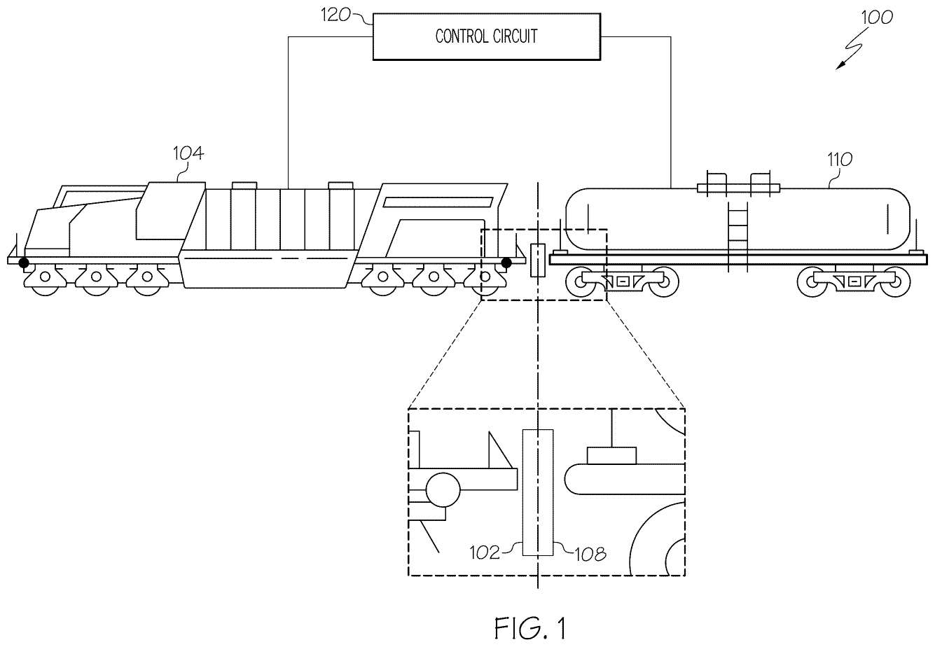

Referring to the figures, FIG. 1 illustrates one example of a multi-vehicle system. The multi-vehicle system 100 can be formed from multiple vehicles, such as a first vehicle 104 and a second vehicle 110. In one embodiment, the vehicles in the multi-vehicle system can be mechanically coupled with each other while in other embodiments the vehicles may remain mechanically uncoupled or separate but may still coordinate their movements so that the vehicles in the vehicle system move together (e.g., in a platoon, convoy, swarm, etc.). Suitable vehicles can be propulsion-generating vehicles (e.g., automobiles, trucks, locomotives, etc.). In the multi-vehicle systems, other suitable vehicles may be non-propulsion-generating vehicles (e.g., tenders, trailers, railcars, etc.).

Because fuel in liquid or gaseous form may be stored on a non-propulsion-generating vehicle, it may be necessary to transfer such fuel to a propulsion-generating vehicle. Accordingly, the vehicles may include an interface device to establish the required connections between vehicles to transfer such fuel. For example, a first interface device 102 may be couplable to the first vehicle and a second interface device 108 may be couplable to the second vehicle. The first interface device and the second interface device may be located intermediate the first and second vehicle, such that when the first and second interface devices are in a state of mated engagement, a connection between the first and second vehicles is established.

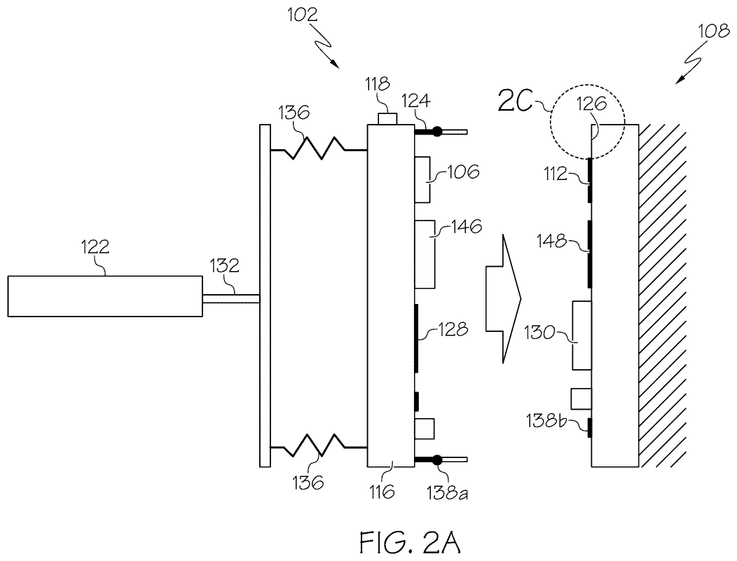

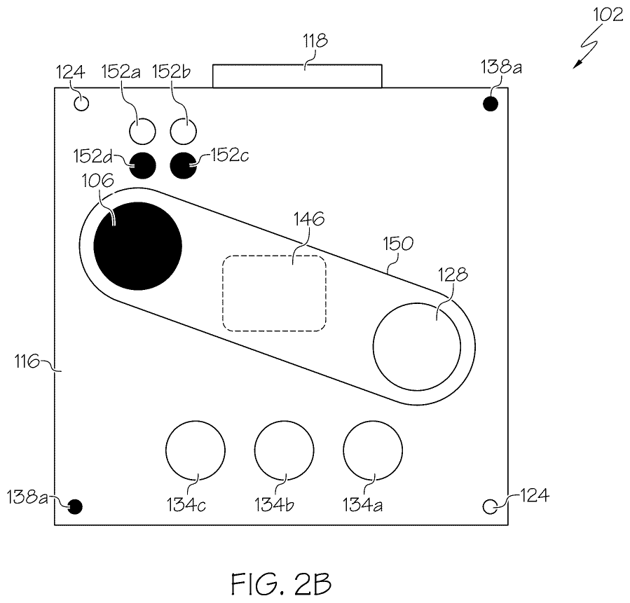

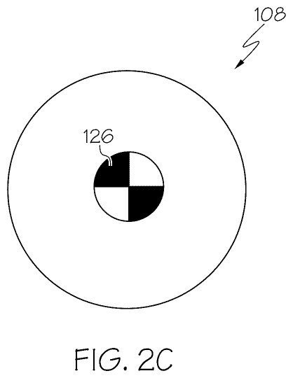

To transfer fuel from one vehicle to another, the vehicles require at least one fluidic connection. As shown in FIGS. 2A and 2B, the first interface device may include a first fuel conduit portion 106 and the second interface device may include a second fuel conduit portion 112. The first conduit portion and the second conduit portion can be fluidically coupled to define a continuous gaseous fuel conduit 114 from the first vehicle to the second vehicle. In one embodiment, the fuel may be gaseous during the transfer. In another embodiment, the fuel may be liquid during the transfer. Suitable fuels may include hydrogen, methane (natural gas), dimethyl ether, diesel, gasoline, kerosene, ethanol (and other alcohols), and the like selected with reference to the end use application.

If fuel is transferred while the vehicles are operational (i.e., in motion), the continuous fuel conduit may need to conform to changes in distance and orientation of the vehicles relative to each other. In one embodiment, the conduit may elastically deform to maintain fluid communication during operation of the first vehicle and the second vehicle while transferring fuel from the first vehicle to the second vehicle. By elastically deforming, the continuous fuel conduit can have adequate slack to accommodate a wide variety of vehicle movements, such as when the vehicles travel around a curve, change speed or acceleration, or move further apart or closer together. Other suitable movements of the conduit may include stretch, deform, articulate, compress, and expand.

The ability of the continuous fuel conduit to elastically deform may be achieved by forming the continuous fuel out of organic materials. Suitable organic materials may include rubber, latex, or polyurethane. Where inorganic materials are used, suitable materials may include silicone and the like. Alternatively, the continuous fuel conduit may be formed out of glass, ceramic, cermets, metal and/or composites of the foregoing. Additionally, the continuous fuel conduit may include features that permit flexibility. For example, the continuous fuel conduit may be or may have a segmented or braided aspect that permits flexibility.

In addition to the first and second fuel conduit portions, the first and second interface devices may include one or more additional connectors, such that when the first and second interface devices are in a state of mated engagement, a plurality of connections can be established. The plurality of connections may include, but are not limited to, at least one of an electrical connection, a communication/signal connection, a power connection, a pneumatic connection, a control system connection, a vaporizing fluid supply, or a vaporizer fluid return. For example, the first interface device can include a first electrical connector 128 and the second interface device can include a second electrical connector 130. The first electrical connector and the second electrical connector can be communicably couplable upon mated engagement of the first interface device and the second interface device. The first interface device may comprise the female mating interfaces of the various connections 152a-d, and the second interface device may comprise the male mating interface of the various connections, or vice versa. Alternatively, the first interface device and the second interface device may have one or both male and female connections.

Further, the first interface device may include a first mechanical connector 146 and the second interface device may include a second mechanical connector 148, such that when the first interface device and second interface device are in a state of mated engagement, the first and second vehicles are mechanically coupled. The mechanical coupling of the first and second vehicles can allow the vehicles of the multi-vehicle system can move together. Alternatively, the first and second mechanical connectors may be separate from the first and second interface devices, respectively. In such embodiments, the first and second vehicle may still mechanically couple upon mated engagement of the first interface device and the second interface device due to the proximity of the first vehicle to the second vehicle.

In further reference to FIG. 2A, in order to establish the fluidic connection between the first interface device and the second interface device, the first interface device may include a plate 116 that is extendable towards the second interface device and may matingly engage the second interface device. The plate may include a moveable arm 132, such that the moveable arm is actuatable to matingly engage the first and second interface devices.

As shown in FIG. 2A, the second interface device may include a stationary plate, such that the second interface device is fixedly attached to the second vehicle. Alternatively, in other aspects of the present disclosure, the second interface device may include a moveable plate (not shown) that is able to extend towards the fist interface device to matingly engage the first interface device. Similarly, although FIG. 2A illustrates the first interface device with the extendable plate and the second interface device as stationary, it is envisioned that both the first interface device and the second interface device may be individually actuatable to achieve mating engagement. Alternatively, it is envisioned that both the first interface device and the second interface device may be stationary, such that the vehicles are required to move into place to establish mating engagement between the first and second interface devices.

The extension of the plate or the arm may be caused by a control circuit 120 which can actuate an actuator 122. The actuator may include a pneumatic valve, an electric motor, or a hydraulic valve, or an actuator selected with reference to the end use parameters. For example, the control circuit may actuate an electric motor to drive a drive screw which could, in turn, cause the extension of the movable plate toward the second interface device. As another example, the control circuit can actuate a pneumatic or hydraulic valve affixed to a pneumatic or hydraulic source to cause the extension.

Because fuel is transferred during operation of the vehicles, it may be necessary in some cases to add compliance in certain directions and rigidity in others to ensure the first and second interface devices remain connected during operation. Accordingly, the moveable arm, or another connection between the plate and the actuator, may be rigid in a first direction but flexible in a second direction to maintain a state of mated engagement between the first interface device and the second interface device while the first and second vehicles are in motion. For example, there may be a compliance feature 136 that creates rigidity along the longitudinal axis of the movable arm but allows for translation in the axial direction. This balance of rigidity in certain directions and flexibility/compliance in other directions may ensure that there is adequate slack between the interface devices to accommodate curves in the vehicle route, changes in speed and/or acceleration, slop in mechanical couplers, or another force that may cause a mismatch of movement between the vehicles. For example, the compliance feature may include springs, rubber mounts, shock absorbers, flexible couplings, and the like selected with reference to end use parameters.

The system may include a latching mechanism 118. The latching mechanism, or latch, may ensure that the mated engagement of the first and second interface device is maintained. The latching mechanism can engage or disengage the first interface device from the second interface device. The latching mechanism may be used to ensure that the system stay coupled during normal operation of the vehicle yet is able to separate in the event of an emergency. For example, a suitable latch may be a mechanically controlled latch, an electrically controlled latch, a pneumatically controlled latch, or a magnetically controlled latch. Additionally, the latching mechanism may be operable by the control circuit. The latching mechanism and control circuit may be connected to a safety sensor or circuit to ensure an adequate connection is maintained during operation of the multi-vehicle system.

As shown in FIG. 2B, in various embodiments, the system may one or more sensors 134a-c. The sensors may be in wired or wireless communication with the control circuit in order to send a plurality of signals regarding the system to the control circuit. Such signals can be used to send information across the multi-vehicle system to ensure optimal operation. In various aspects, the signals may be used to establish a feed forward-feedback control loop to establish a fuel demand between various vehicles to provide more coordinate control of fueling. For example, the propulsion generating vehicle can send a signal to the control circuit indicating that additional fuel may be required. Alternatively, a sensor within the system may detect that additional fuel is necessary (e.g., the sensor may detect that the power supply on the propulsion-generating vehicle has become active) and send a signal to the control circuit indicating that fuel may be required. The control circuit may then send a signal to the vaporizer, or other similar system, that additional gas needs to be produced, such that the vaporizer can begin heating. Additionally, the control circuit may send a signal to the fuel storage system to begin building pressure. The control circuit may signal as necessary to prepare the fuel in order to send it forward to the propulsion-generating vehicle. Similarly, signals may be sent back to the control circuit from one of the sensors on the system to monitor and adjust the operation of the vehicle based on a detected parameter from the sensors.

Referring again to FIGS. 2A-2C, the system may include a first sensor 124, which may be a transmitter, and a second sensor 126, which may be a receiver. The control circuit may communicate with at least the first and second sensors to determine when to cause the extension of the plates. Accordingly, the first sensor (the transmitter) can emit a signal that is received by the second sensor (the receiver) which is indicative of the distance between the two sensors. Once the detected distance is below a determined distance, the sensors may send a signal to the control circuit that the plates are close enough to be extended in order to achieve mating engagement between the first interface device and the second interface device. In one embodiment, the determined distance may be a based at least in part on the length of the moveable arm or fully extended length of the actuator/plate.

In various other aspects of the present disclosure, the one or more sensors may be used to ensure proper alignment of the first interface device and second interface device in making the connection. The alignment may be achieved, for example, via video camera sensor(s), ultrasonic sensor(s), eddy current sensor(s), optical sensor(s), contact switch(es), etc. In various alternative aspects, the alignment between the first and second interface devices may be achieved using mechanical alignment features 138a-b, such as a pin and collet, a ball and socket, an aperture and a protrusion, a set of teeth, etc.

Additionally, due to the high volatility of some fluids, it may be desirable to have redundancy features built into the system for additional safety. This redundancy may be achieved by using the one or more sensors may be used to detect a variety of states of the system. For example, the system may include a sensor that can detect a state of mated engagement of the first interface device and the second interface device to prevent the first vehicle and second vehicle from moving based on the state of mated engagement detected by the sensor. As such, prior to operating the first and second vehicles, if the sensor detects that the first interface device and second interface are in a state of mated engagement, the system will not prevent the first and second vehicles from operating. Instead, the system will allow the first and second vehicle to start standard operation. However, if the sensor detects that the first interface device and second interface device are not in a state of mated engagement, the system will prevent the first and second vehicles from operating. Such a sensor may be integrated with the latching mechanism, as described above.

Similarly, the sensor may detect a state of separation of the first interface device and second interface device to stop the first vehicle and the second vehicle from operating based on a detected state of separation during operation of the first and second vehicle. As such, the sensor may be used to detect if the first and second interface plates have separated during operation, such that the first and second interface plates are no longer matingly engaged. If so, the sensor may send a signal to the control circuit, indicating that the operation of the multi-vehicle system should be stopped. Such a sensor may be integrated with the latching mechanism, as described above.

In various aspects of the present disclosure, the sensors may be in communication with the emergency brake line, emergency shut off system, or another emergency system of the multi-vehicle system in order to stop operation of the multi-vehicle system. For example, if the sensor detects a state of separation or detects that the first and second interface plates are not in mated engagement, the multi-vehicle system can switch operational modes. In one embodiment, it may shut down to stop all operations. The system may include a sensor for detecting hydrogen near the connectors. Such a sensor may be used to detect whether hydrogen is leaking and send an alert or cause the system to stop flowing to reduce or to prevent further leaking.

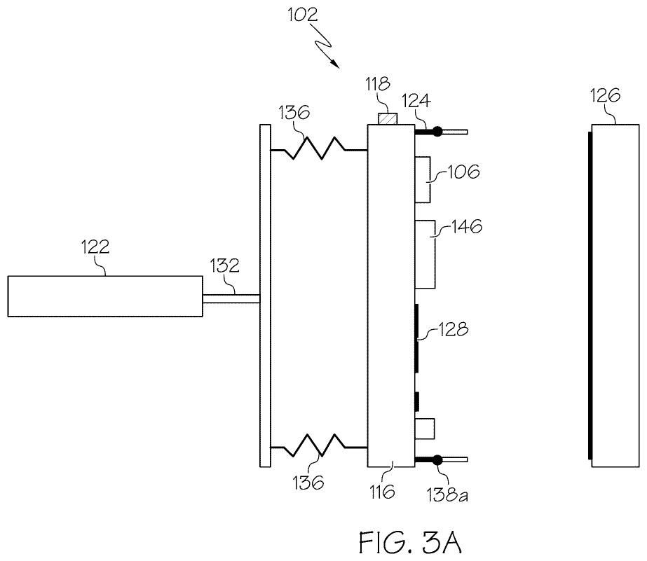

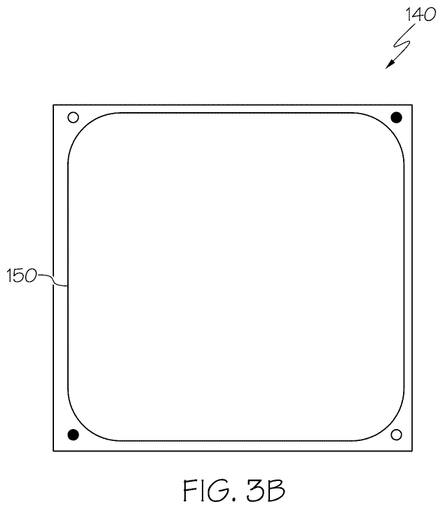

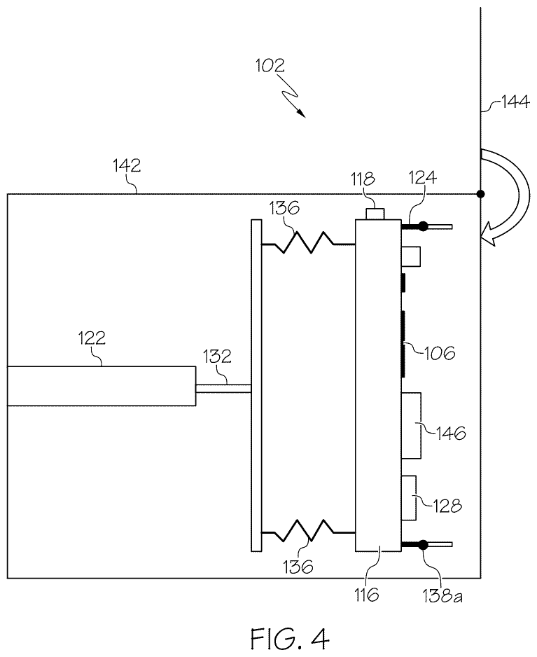

Referring now to FIGS. 3 and 4, to ensure the highest quality of fuel is transferred between the vehicles, it may be desirable to ensure there are not contaminants within one of the connections, but particularly in the continuous fuel conduit, of the system prior to transferring fuel. One way to ensure contaminants are not within the continuous fuel line is to ensure that the interface devices are sealed and protected to prevent contaminants from accessing the connectors when the system is not in mated engagement.

As shown in FIG. 3, one example of a protection system is a protective cover 140 that is placed over one or both of the interface devices when they are not in mated engagement. The protective cover may be attached to the interface device in a secure manner. Securing may use bolts, screws, snaps, latches, adhesives, etc.

The protective cover may include a seal 150. The seam may help to protect the connections from contaminants. The seal may be positioned partially or fully near the exterior of the protective cover, such that the entire interface device is sealed from exterior contaminants. The interface device may have a corresponding groove to interface with the seal. In various aspects, there may be a seal around each individual connector and/or around a group of connectors (e.g., some or all of the electrical connectors).

As shown in FIG. 4, an additional example of a protection system may include a protective compartment 142 with a door 144. The protective compartment may extend into the vehicle, such that the interface device is positioned inside the protective compartment until the vehicles are prepared to be matingly engaged. Once the vehicles are adequately positioned, the door may open automatically. For example, the door may include a latch that is released by the control circuit upon receiving a signal that the first and second vehicle are within close proximity to each other. Alternatively, the door may be manually opened via the force of the interface device moving from the protective compartment to engage with the second interface device.

Like the protective cover, the door may include a seal to further protect the interface device and the corresponding connections from contaminants. The seal may be positioned around the perimeter of the door, such that when the door is closed, the seal ensures that no exterior contaminants are able to enter the protective compartment.

Regardless of the type of protective system, it may be desirable to ensure that the system is automatically engaged upon detection of disengagement between the first interface device and second interface device. For example, in a situation where the first and second interface devices have separated, it would be desirable to engage the protection system to ensure that no fluids leak out of the vehicles. Accordingly, when a state of separation is detected, the protective system may be automatically engaged to prevent further leaking. This may be achieved by automatically covering the interface device and/or retracting the interface device into the protective compartment.

It may be desirable to prevent contaminants from entering, or to remove contaminants from interface devices prior to transferring fuel. Contaminants such as air, debris, water, or another undesirable matter that is not fuel can cause damage to the entire multi-vehicle system if not adequately removed prior to operation of the system. For example, fuel cells of an engine can be extremely sensitive to contaminants such as air. Accordingly, at least one of the interface devices may release a burst of hydrogen, compressed air, inert gas, or another suitable fluid to reduce or remove debris or dirt from the interface devices prior to matingly engaging the interface devices. Alternatively, at least one of the interface devices may use a vacuum to evacuate contaminants.

Contaminants may be reduced or removed from the fuel conduit prior to transferring fuel. For example, at least one of the interface devices may purge the continuous fuel conduit of contaminants during fluidic coupling of the first conduit portion and the second conduit portion. The purge of contaminants may occur after connecting to ensure that no additional contaminants infiltrate the fuel conduit. The contaminants may be released through a vent or port that allows contaminants to escape the continuous fuel line.

The system may include additional seals, such as a seal between the first interface device and second interface device, to ensure that no contaminants enter the system during operation of the vehicles. For example, there may be a seal around each individual connector or around a group of connectors (e.g., some or all of the electrical connectors). In various other aspects, there may be a seal at least that extends at least partially near the perimeter of the interface devices. In some aspects, the first interface device may have the seal and the second interface device may define a groove to house the seal, or vice versa.

In one embodiment, a vehicle may include two or more interface devices. The vehicle devices may be positioned the front or rear of the vehicle, such that the interface devices can be used to connect a vehicle to an adjacent vehicle. In various aspects of the present disclosure, there may be a combination of first interface devices and second interface devices located at various points of each vehicle to ensure that adequate connections can be made between two vehicles of the multi-vehicle system, regardless of the orientation or position of the vehicle within the multi-vehicle system.

Further, not all interface devices may be connected to operate the multi-vehicle system. For example, if two non-propulsion-generating vehicles are located adjacent to each other, and fuel does not need to transfer between them, they may not be connected. However, if, at a later time, fuel needs to be transferred between those vehicles, the interface devices may be used to create a fluidic connection between the two vehicles.

Similarly, even vehicles that do not transfer fuel may include at least one interface device. For example, some vehicles, whether propulsion generating or non-propulsion generating, may accommodate passive flow through of the fuel. It may be desirable to create a large separation between the fuel storage and the active propulsion-generating vehicle for safety purposes. Similarly, it may be desirable to have multiple fuel storage vehicles to improve the range of the multi-vehicle system. In such situations, it may be necessary to passively flow the fuel through other vehicles in the multi-vehicle system, thereby warranting adequate connections between additional vehicles in the system, outside of those used for fueling and propulsion generation.

Further, although primarily discussed with reference to the connection between the first and second interface devices to establish a state of mated engagement between the two interface devices, it is envisioned that the reverse is possible for disconnection. For example, it is envisioned that the latching mechanism can release and the actuators can separate the first interface device from the second interface device when necessary.

In an alternative embodiment, the system can include a first interface plate couplable to a first vehicle and a second interface plate couplable to a second vehicle. The first interface plate may include a moveable arm, a first connector, and a first alignment feature. The second interface plate can include a second connector that can matingly engage the first connector and a second alignment feature that can receive the first alignment feature. The connectors and the alignment feature can include connectors or alignment features as described. Additionally, the movable arm can be actuatable to matingly engage the first connector and the second connector. For example, the first interface plate can extend toward the second interface plate to matingly engage the first interface plate to the second interface plate. As such, the mating engagement of the first connector and the second connector can define a fuel conduit which may elastically deform to maintain fluid communication during operation of the first vehicle and the second vehicle while transferring caseous fuel from the first vehicle to the second vehicle.

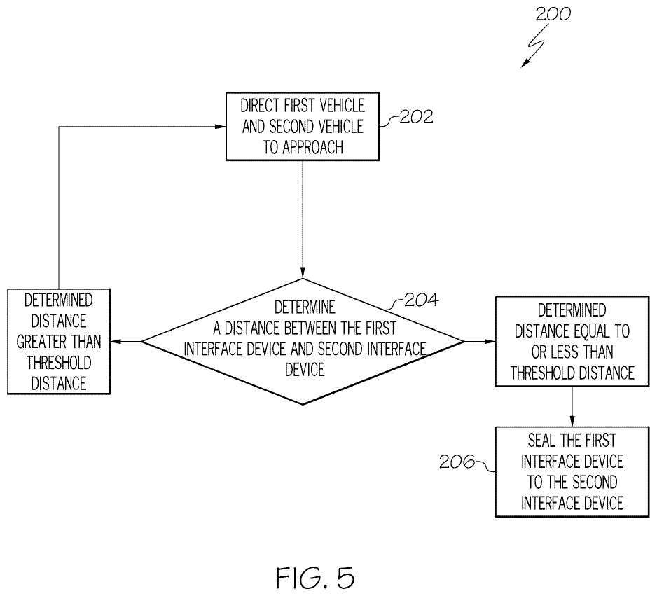

FIG. 5 illustrates a flow diagram of one example of a method 200 for interfacing the two vehicles. The method can represent operations for engaging a first interface device with a second interface device, as described above. The method includes directing 202 a first vehicle with a first interface device and a second vehicle with a second interface device to approach each other. The method further includes determining 204 a distance between the first interface device and the second interface device. If the determined distance is less than or equal to a threshold distance, the method further comprises sealing 206 the first interface device to the second interface device to define a fluidic connection between the first vehicle and the second vehicle. However, if the determined distance is not less than the threshold distance, then the method continues directing the first vehicle and the second vehicle to approach each other.

The method may include purging contaminants from a fuel conduit fluidically coupled between the first interface device and the second interface device. The method may include detecting engagement of the gas tight seal between the first interface device and the second interface device and permitting operation of the first vehicle and the second vehicle based on the detected engagement of the gas tight seal. The method may include stopping the first vehicle and the second vehicle based on a disengagement of the gas tight seal during operation of the first vehicle and the second vehicle.

The subject matter described herein extends to other types of vehicle systems, such as automobiles, trucks (with or without trailers), buses, marine vessels, aircraft, mining vehicles, agricultural vehicles, or other off-highway vehicles. The vehicle systems described herein (rail vehicle systems or other vehicle systems that do not travel on rails or tracks) may be formed from a single vehicle or multiple vehicles. With respect to multi-vehicle systems, the vehicles may be mechanically coupled with each other (e.g., by couplers) or logically coupled but not mechanically coupled. For example, vehicles may be logically but not mechanically coupled when the separate vehicles communicate with each other to coordinate movements of the vehicles with each other so that the vehicles travel together (e.g., as a convoy).

In one embodiment, the control circuit, control circuit, and systems described herein may use machine learning to make determinations and to enable derivation-based learning outcomes. The system may communicate with a data collection system. The control circuit may learn from, model and make decisions/determinations on a set of data (including data provided by various sensors and data collection systems) by making data-driven predictions and adapting according to available data and modeling. Machine learning may involve performing tasks using supervised learning, unsupervised learning, and reinforcement learning systems. Supervised learning may use a set of example inputs and desired outputs to the machine learning systems, where unsupervised learning may use a learning algorithm that is structuring its input with, e.g., pattern detection and/or feature learning. Reinforcement learning may perform in a dynamic environment and then provide feedback about correct and incorrect decisions. Machine learning may include tasks based on certain outputs. These tasks may be machine learning problems such as classification, regression, clustering, density estimation, dimensionality reduction, anomaly detection, and the like to include other mathematical and statistical techniques. Suitable machine learning algorithmic types may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for making determinations, calculations, comparisons and behavior analytics, and the like.

In one embodiment, the control circuit may include a policy engine. The policies the engine may apply can be based at least in part on characteristics of a given item of equipment or environment. For example, an artificial intelligence system, such as a neural network, can receive input of a number of environmental and task-related parameters. These parameters may include, for example, operational input of the given equipment, data from various sensors, environmental information, location and/or position data, and the like. The neural network can be trained and can generate an output based on these inputs, with the output representing an action or sequence of actions that the equipment or system should take to accomplish the goal of the operation. The control circuit can process the inputs through the parameters of the neural network to generate a value (i.e., make a determination) at the output node designating that action as the desired action, activity, or operating state. An action may translate into a signal that causes the vehicle to operate in a particular manner. The control circuit may accomplish this via back-propagation, feed forward processes, closed loop feedback, or open loop feedback, for example. Alternatively, rather than using backpropagation, the control circuit may use evolution strategies techniques to tune various parameters of the neural network. The control circuit may use neural network architectures that have a set of parameters representing weights of its node connections. A number of copies of this network can be generated and adjustments to the parameters can be made with subsequent simulations. Once the outputs from the various models have been obtained, they may be evaluated on their performance using a determined success metric. The best model is selected, and the control circuit can execute that plan to achieve the desired input data to mirror the predicted best outcome scenario. Additionally, the success metric itself may be a combination of the optimized outcomes, which may be weighed relative to each other. Success metrics may be dynamically established, and the process rerun and the equipment directions further modified.

In one embodiment, data can be generated, transmitted, and stored and may involve one or both of a protected space data source and the exposed space data source. The control circuit may encrypt and decrypt data as needed at rest, during use, or in transit. Encryption keys and schema may be selected and implemented as informed by end use parameters and requirements. The control circuit may evaluate and/or identify a decision boundary (that is, a boundary that separates desired behavior from undesired behavior) with regard to that data. If the control circuit determines that some quantity of data is from a protected space data source and/or is operating within determined boundaries then the control circuit, and the equipment being controlled, may operate normally. However, if the data is determined to be from an exposed space data source and/or it crosses the decision boundary, the control circuit may respond. Suitable responses may be to power down determined equipment, signal an alert, run a diagnostic routine, perform a data backup (without overwriting existing backup data), isolate equipment (including by suspending some or all communication pathways), switch equipment or control operations to a safe mode of the control system, and/or initiate a safe mode state of the equipment (e.g., slow a vehicle to a safe and controlled stop). The safe mode may be, in one embodiment, a soft shutdown mode that it intended to avoid damage or injury based on the shutdown itself and in another embodiment may be a reboot and/or minimal reload of essential drivers and functionality.

In one embodiment, a system includes first interface device couplable to a first vehicle device. The first interface device includes a first fuel conduit portion. The system also includes a second interface device couplable to a second vehicle. The second interface device includes a second fuel conduit portion. The first fuel conduit portion and the second fuel conduit portion are fluidically coupled to define a continuous fuel conduit from the first vehicle to the second vehicle and the continuous fuel conduit that can elastically deform to maintain fluid communication during operation of the first vehicle and the second vehicle while transferring fuel from the first vehicle to the second vehicle.

Additionally, in the first embodiment, the first interface device includes a first plate that is extendable towards the second interface device, and that can matingly engage the second interface device; or the system includes a control circuit that that can cause the extension of the first plate; or the control circuit that can actuate a pneumatic valve, an electric motor, or a hydraulic valve to cause the extension; or the first interface device includes a first electrical connector, the second interface device includes a second electrical connector, and the first electrical connector and the second electrical connector are communicably couplable upon mated engagement of the first interface device and the second interface device; or the system includes a sensor that can detect a state of mated engagement of the first interface device and the second interface device to prevent the first vehicle and the second vehicle from moving based on a state of mated engagement detected by the sensor; or the sensor that can detect a state of separation of the first interface device and the second interface device to stop the first vehicle and the second vehicle from operating based on a detected state of separation during operation of the first vehicle and the second vehicle. Alternatively, in the first embodiment, the system includes a first sensor and a second sensor. The first sensor is a transmitter and the second sensor is a receiver. The system can include a control circuit to communicate with at least one of the first or the second sensors to determine when to cause an extension of the first plate.

Alternatively, in the first embodiment, the system includes a latch that can engage or disengage the first interface device from the second interface device, and the latch is actuatable by a control circuit. Alternatively, the first interface device of the first embodiment includes a first electrical connector, the second interface device includes a second electrical connector, and the first electrical connector and the second electrical connector are communicably couplable upon mated engagement of the first interface device and the second interface device. Alternatively, in the first embodiment, the system includes a moveable arm that is rigid in a first direction and flexible in a second direction to maintain a state of mated engagement while the first interface device and the second interface device are in the state of mated engagement and the first and second vehicles are in motion. Alternatively, in the first embodiment, one of the first interface device or the second interface device that can purge the continuous fuel conduit of contaminants during fluidic coupling of the first conduit portion and the second conduit portion.

In a second embodiment, the present disclosure provides a system that includes a first interface plate couplable to a first vehicle. The first interface plate includes a moveable arm, a first connector, and a first alignment feature. The system also includes a second interface plate couplable to a second vehicle. The second interface plate includes a second connector that can matingly engage the first connector and a second alignment feature that can receive the first alignment feature. The moveable arm is actuatable to matingly engage the first connector to the second connector.

Additionally, the first interface plate of the second embodiment is extendable toward the second interface plate to matingly engage the first interface plate to the second interface plate, the mating engagement of the first connector and the second connector defines a fuel conduit, and the fuel conduit that can elastically deform to maintain fluid communication during operation of the first vehicle and the second vehicle while transferring fuel from the first vehicle to the second vehicle.

Additionally, the second embodiment includes at least one of a motor to actuate a drive screw to extend the moveable arm affixed to the drive screw, or a pneumatic valve to activate a hydraulic source to extend the moveable arm affixed to a hydraulic source; or the moveable arm of the second embodiment is rigid in a first direction and flexible in a second direction to maintain a state of mated engagement while the first interface plate and the second interface plate are in a state of mated engagement are in motion; or the second embodiment includes a sensor that can detect a state of mated engagement of the first interface plate and the second interface plate and a state of separation of the first interface plate and the second interface plate, the first vehicle and the second vehicle are prevented from moving based on a state of mated engagement detected by the sensor, and the first vehicle and the second vehicle can slow or stop movement based on a state of separation detected by the sensor during operation during operation of the first vehicle and the second vehicle.

In a third embodiment, the disclosure provides a method that includes directing a first vehicle with a first interface device and a second vehicle with a second interface device to approach each other; determining a distance between the first interface device and the second interface device; and sealing the first interface device to the second interface device in response to the determined distance being less than a threshold distance to define a fluidic connection between the first vehicle and the second vehicle.

Additionally, the third embodiment includes purging contaminants from a fuel conduit fluidically coupled between the first interface device and the second interface device; or detecting engagement of the gas tight seal between the first interface device and the second interface device and permitting operation of the first vehicle and the second vehicle based on the detected engagement of the gas tight seal; or stopping the first vehicle and the second vehicle based on a disengagement of the gas tight seal during operation of the first vehicle and the second vehicle.

This written description uses examples to disclose several embodiments of the subject matter, including the best mode, and to enable one of ordinary skill in the art to practice the embodiments of subject matter, including making and using devices or systems and performing incorporated methods. The patentable scope of the subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A system, comprising:
a first interface device couplable to a first vehicle, the first interface device comprising a first fuel conduit portion; and
a second interface device couplable to a second vehicle, the second interface device comprising a second fuel conduit portion, the first fuel conduit portion and the second fuel conduit portion are fluidically coupled to define a continuous fuel conduit from the first vehicle to the second vehicle, the continuous fuel conduit is configured to dynamically move or deform to maintain fluid communication during operation of the first vehicle and the second vehicle while transferring fuel from the first vehicle to the second vehicle.

2. The system of claim 1, wherein the fuel is a gaseous fuel and the continuous fuel conduit comprises an elastomer.

3. The system of claim 1, wherein the first interface device comprises a first plate that is extendable towards the second interface device and is configured to matingly engage the second interface device.

4. The system of claim 3, comprising a control circuit that is configured to cause the extension of the first plate, and the control circuit is configured to actuate a pneumatic valve, an electric motor, or a hydraulic valve to cause the extension.

5. The system of claim 2, comprising a first sensor and a second sensor, wherein the first sensor is a transmitter and the second sensor is a receiver, and a control circuit to communicate with at least one of the first or the second sensors to determine when to cause an extension of the first plate.

6. The system of claim 1, further comprising a latch configured to engage or disengage the first interface device from the second interface device, wherein the latch is actuatable by a control circuit.

7. The system of claim 2, wherein the first interface device comprises a first electrical connector, and the second interface device comprises a second electrical connector, and wherein the first electrical connector and the second electrical connector are communicably couplable upon mated engagement of the first interface device and the second interface device.

8. The system of claim 1, comprising a moveable arm that is rigid in a first direction and flexible in a second direction to maintain a state of mated engagement while the first interface device and the second interface device are in the state of mated engagement and the first and second vehicles are in motion.

9. The system of claim 2, comprising a sensor configured to detect a state of mated engagement of the first interface device and the second interface device to prevent the first vehicle and the second vehicle from moving based on a state of mated engagement detected by the sensor.

10. The system of claim 9, wherein the sensor is further configured to detect a state of separation of the first interface device and the second interface device to switch a mode of operation in response to a detected state of separation during operation of the first vehicle and the second vehicle.

11. The system of claim 1, wherein one of the first interface device or the second interface device is configured to purge the continuous fuel conduit of contaminants during fluidic coupling of the first conduit portion and the second conduit portion.

12. A system, comprising:
a first interface plate couplable to a first vehicle, the first interface plate comprising:
a moveable arm,
a first connector, and
a first alignment feature;
a second interface plate couplable to a second vehicle, the second interface plate comprising:
a second connector configured to matingly engage the first connector,
a second alignment feature configured to receive the first alignment feature,
the moveable arm is actuatable to matingly engage the first connector to the second connector;
wherein the first interface plate is extendable toward the second interface plate to matingly engage the first interface plate to the second interface plate, the mating engagement of the first connector and the second connector defines a fuel conduit, the fuel conduit responsive to relative motion of the first vehicle and the second vehicle while transferring fuel therebetween to maintain a flow of the fuel.

13. The system of claim 12, comprising at least one of:
a motor to actuate a drive screw to extend the moveable arm affixed to the drive screw; or
a pneumatic valve to activate a hydraulic source to extend the moveable arm affixed to a hydraulic source.

14. The system of claim 12, wherein the moveable arm is rigid in a first direction and flexible in a second direction to maintain a state of mated engagement while the first interface plate and the second interface plate are in a state of mated engagement are in motion.

15. The system of claim 12, comprising a sensor configured to detect a state of mated engagement of the first interface plate and the second interface plate and a state of separation of the first interface plate and the second interface plate, wherein the first vehicle and the second vehicle are prevented from moving based on a state of mated engagement detected by the sensor, and wherein the first vehicle and the second vehicle are configured to stop operating based on a state of separation detected by the sensor during operation during operation of the first vehicle and the second vehicle.

16. The system of claim 12, wherein the fuel is a gaseous fuel and the fuel conduit comprises an elastomer.

17. A method, comprising:
directing a first vehicle with a first interface device and a second vehicle with a second interface device to approach each other;
determining a distance between the first interface device and the second interface device; and
sealing the first interface device to the second interface device in response to the determined distance being less than a threshold distance to define a fluidic connection between the first vehicle and the second vehicle.

18. The method of claim 17, further comprising purging contaminants from a fuel conduit fluidically coupled between the first interface device and the second interface device.

19. The method of claim 17, comprising detecting engagement of the seal between the first interface device and the second interface device and permitting operation of the first vehicle and the second vehicle based on the detected engagement of the seal.

20. The method of claim 17, comprising stopping a flow of fuel responsive to a break in the seal.
